(19) United States
(12) Patent Application Publication
(10) Pub. No.: US 2010/0215991 A1
(43) Pub. Date: Aug. 26, 2010

(54) PERPENDICULAR MAGNETIC RECORDING MEDIUM, PROCESS FOR PRODUCING PERPENDICULAR MAGNETIC RECORDING MEDIUM, AND MAGNETIC RECORDING/REPRODUCING APPARATUS

(75) Inventors: Gohei Kurokawa, Chiba (JP); Yuzo Sasaki, Chiba (JP); Tatsu Komatsuda, Chiba (JP); Atsushi Hashimoto, Chiba (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Tokyo (JP)

(21) Appl. No.: 12/671,452

(22) PCT Filed: Jul. 25, 2008
(86) PCT No.: PCT/JP2008/063418

§ 371 Date: Apr. 29, 2010

(30) Foreign Application Priority Data
Jul. 30, 2007 (JP) 2007-197316

(51) Int. Cl. G11B 5/706; G11B 5/84

(52) U.S. Cl. 428/846.7; 428/846; 428/846.6; 428/846.8; 427/131

(57) ABSTRACT

A perpendicular magnetic recording medium is provided, which has a soft magnetic layer, a seed layer, a first intermediate layer, a second intermediate layer and a perpendicular magnetic recording layer, formed in this order on a non-magnetic substrate, and is characterized in that the seed layer is comprised of a (002) crystal plane-orientated hcp structure, the first intermediate layer is comprised of a (110) crystal plane-orientated bcc structure and the second intermediate layer is comprised of a (002) crystal plane-orientated hcp structure. The (110) crystal plane-orientated bcc structure comprises at least 60 atomic % of Cr. The magnetic recording medium has fine and well discrete magnetic crystal grains with extremely small size and exhibits good perpendicular orientation in the perpendicular magnetic recording layer, and thus, the medium is capable of recording and reproducing information with high density.

### TECHNICAL FIELD

This invention relates to a perpendicular magnetic recording medium, a process for producing the perpendicular magnetic recording medium, and a magnetic recording reproducing apparatus provided with the perpendicular magnetic recording medium.

### BACKGROUND ART

In recent years, magnetic recording apparatuses such as a magnetic disk apparatus, a flexible disk apparatus and a magnetic tape apparatus are widely used and their importance is increasing. Recording density of a magnetic recording medium provided with the magnetic recording apparatuses is greatly enhanced. Especially, since the development of an MR head and a PRML technique, the plane recording density is more and more increasing. Recently a GMR head and a TuMR head have been developed, and the rate of increase in the plane recording density is about 30% to 40% per year.

There is still increasing a demand for further enhancing the recording density in magnetic recording media, and therefore, a magnetic layer having a higher coercive force and a higher signal-to-noise ratio (S/N ratio), and a higher resolution are eagerly desired.

In longitudinal magnetic recording media heretofore widely used, a self-demagnetization effect becomes significantly manifested, that is, adjacent magnetic domains in magnetic transition regions exhibit a function of counteracting the magnetization each other with an increase in a line recording density. To minimize the self-demagnetization effect, thickness of the magnetic recording layer must be reduced to enhance the shape magnetic anisotropy.

However, with a decrease in thickness of the magnetic recording layer, the magnitude of energy barrier for keeping the magnetic domains approximates to the magnitude of heat energy, and consequently, the heat fluctuation occurs, i.e., the recorded magnetization is reduced by the influence of the temperature. This undesirable phenomenon is said to put an upper limit on the line recordation density.

Recently, an anti-ferromagnetic coupling (AFC) medium has been proposed as means for solving the problem of limitation in the line magnetic recording density in the longitudinal magnetic recording media, which problem arises due to the alleviation of magnetization upon heating.

Perpendicular magnetic recording media attract widespread attention as means for enhancing the plane magnetic recording density. The perpendicular magnetic recording media are characterized in that the magnetization occurs in a direction perpendicular to the major surface of the magnetic recording media, which is in a contrast to the transitional longitudinal magnetic recording media wherein the magnetization occurs in an in-plane direction. Due to this characteristic, the undesirable magnetization-counteracting function as encountered as an obstacle for enhancing the line recording density in the longitudinal magnetic recording media can be avoided, and the magnetic recording density can be more enhanced. Further, the thickness of magnetic recording layer can be maintained at a certain level, and thus, the problem of alleviation of magnetization upon heating as encountered in the traditional longitudinal magnetic recording media can be minimized.

In the manufacture of perpendicular magnetic recording media, a seed layer, an intermediate layer, a magnetic recording layer and a protective layer are usually formed in this order on a non-magnetic substrate. Further, a lubricating layer is often formed on the uppermost protective layer. In many magnetic recording media, a magnetic layer called as a soft magnetic layer is formed beneath the seed layer. The intermediate layer is formed for the purpose of improving the characteristics of the intermediate layer and the magnetic recording layer, more specifically, for providing desired crystal orientation and controlling the shape of magnetic crystals in the intermediate layer and the magnetic recording layer.

To produce perpendicular magnetic recording media having a high recording density and improved magnetic characteristics, the crystalline structure of the magnetic recording layer is important. In perpendicular magnetic recording mediums, the crystalline structure in the magnetic recording layer is often a hexagonal close-packed (hcp) structure. In this crystalline structure, it is important that the (002) crystal plane is parallel to the substrate surface, that is, the crystalline c-axes (i.e., [002] axes) are orientated in the perpendicular direction with minimized disturbance.

To minimize the disturbance of the crystalline orientation in the magnetic recording layer, the intermediate layer in the perpendicular magnetic recording layer has been comprised of ruthenium having a hexagonal close-packed (hcp) structure, which is similar to the conventional magnetic recording mediums. In this magnetic recording layer, epitaxial growth of magnetic crystals in the magnetic recording layer occurs on the (002) crystal plane of ruthenium and therefore the resulting magnetic recording medium exhibits good crystal orientation (see, for example, patent document 1, cited below).

That is, enhancement of crystal orientation on the (002) crystal plane of ruthenium in the ruthenium intermediate layer leads to the improvement in the crystal orientation of the magnetic recording layer. Therefore, the enhancement of crystal orientation on the (002) crystal plane of ruthenium is essential for the improvement in the recording density of the perpendicular magnetic recording mediums. However, if the ruthenium intermediate layer is formed directly on an amorphous soft magnetic layer, the thickness of the intermediate layer must be large to maintain the good crystal orientation. The large thickness of the non-magnetic ruthenium intermediate layer undesirably weakens the soft magnetic layer's attraction of magnetic flux from a head.

To avoid this disadvantage, it has heretofore been adopted to form a (111) crystal face-orientated seed layer with a fcc structure intervening between the soft magnetic layer and the ruthenium intermediate layer (see, for example, patent document 2, cited below). The seed layer with a fcc structure give a high crystal orientation even though it is thin, and, even when the ruthenium intermediate layer directly formed on the fcc seed layer is thin, a good crystal orientation can be obtained. This is in contrast to the above-mentioned recording medium which gives a high crystal orientation only when a ruthenium intermediate layer directly formed on the soft magnetic layer is thick.

However, the formation of the ruthenium intermediate layer on the seed layer has a problem such that the size of ruthenium crystal grains on the fcc seed layer is difficult to control and undesirably becomes large. This leads also to an increase in the size of crystal grains of magnetic cobaly alloy in the magnetic recording layer formed on the intermediate layer. The thus-obtained magnetic recording medium exhibits an increased noise and deteriorated recording/reproducing characteristics.

A proposal has been made wherein a ruthenium intermediate layer is formed on a (002) crystal face-orientated Mg or Ti seed layer with a hcp structure whereby the size of ruthenium crystal grains is reduced (see, for example, patent document 3, cited below). However, this proposal still has a problem such that there is a large difference in the lattice constant a of (002) orientated crystal face between Mg or Ti in the seed layer and Ru in the intermediate layer, and therefore the crystal orientation is poor. This leads to increase in noise and deterioration of recording/reproducing characteristics.

Thus, in order to provide a magnetic recording medium having more improved recording and reproducing characteristics, it is necessary desired that the crystal grain size is more reduced, and the perpendicular crystal orientation are more enhanced. Thus, a magnetic recording medium having more improved recording and reproducing characteristics, which can be easily produced, is eagerly desired.

Patent document 1: JP 2001-6158 A1

Patent document 2: JP 2005-190517 A1

Patent document 3: JP 2006-155865 A1

### DISCLOSURE OF THE INVENTION

### Problems to be Solved by the Invention

In view of the foregoing background art, a primary object of the present invention is to provide a magnetic recording medium characterized as exhibiting reduced size of magnetic crystal grains as well as good perpendicular crystal orientation in the perpendicular magnetic recording layer, and thus, characterized as being capable of recording and reproducing information with high density.

Another object of the present invention is to provide a process for producing the magnetic recording medium having the above-mentioned beneficial characteristics.

A further object of the present invention is to provide a magnetic recording reproducing apparatus provided with a magnetic recording medium having the above-mentioned beneficial characteristics.

### Means for Solving the Problems

In accordance with the present invention, there are provided the following magnetic recording mediums, the following process for producing the magnetic recording medium, and the following magnetic recording reproducing apparatus.

(1) A perpendicular magnetic recording medium comprising at least a soft magnetic layer, a seed layer, an intermediate layer and a perpendicular magnetic recording layer, which are formed in this order on a non-magnetic substrate, characterized in that said seed layer is comprised of a (002) crystal plane-orientated hexagonal close-packed (hcp) structure, and said intermediate layer comprises a first intermediate layer comprised of a (110) crystal plane-orientated body-centered cubic (bcc) structure and a second intermediate layer comprised of a (002) crystal plane-orientated hexagonal close-packed (hcp) structure, wherein the first intermediate layer and the second intermediate layer have been formed in this order.
(2) The perpendicular magnetic recording medium as described above in (1), wherein the soft magnetic layer has a non-crystalline structure.
(3) The perpendicular magnetic recording medium as described above in (1) or (2), wherein the seed layer is a (002) crystal plane-orientated bcc structure mainly comprised of an element selected from the group consisting of Mg, Ti, Zr, Hf, Y, Ru, Re, Os and Zn.
(4) The perpendicular magnetic recording medium as described above in anyone of (1) to (3), wherein the (110) crystal plane-orientated bcc structure constituting the first intermediate layer comprises at least 60 atomic % of chromium.
(5) The perpendicular magnetic recording medium as described above in anyone of (1) to (4), wherein the (110) crystal plane-orientated bcc structure constituting the first intermediate layer comprises chromium as a main ingredient and further comprises at least one element selected from the group consisting of Pt, Ir, Pd, Au, Ni, Al, Ag, Cu, Rh, Pb, Co, Fe, Mn, V, Nb, Ta, Mo, W, B, C, Si, Ga, In, Ti, Zr, Hf, Ru and Re.
(6) The perpendicular magnetic recording medium as described above in anyone of (1) to (5), wherein the (110) crystal plane-orientated bcc structure constituting the first intermediate layer is comprised of crystal grains having an average grain diameter in the range of 3 nm to 10 nm.
(7) The perpendicular magnetic recording medium as described above in anyone of (1) to (6), wherein the (110) crystal plane-orientated bcc structure constituting the first intermediate layer has a thickness in the range of 1 nm to 50 nm.
(8) The perpendicular magnetic recording medium as described above in any one of (1) to (7), wherein the (002) crystal plane-orientated hcp structure constituting the second intermediate layer comprises ruthenium or a ruthenium alloy.
(9) The perpendicular magnetic recording medium as described above in any one of (1) to (8), wherein the perpendicular magnetic recording layer comprises at least one magnetic layer having a granular structure comprising ferromagnetic crystal grains and crystal boundaries comprised of a non-magnetic oxide.
(10) A process for producing a perpendicular magnetic recording medium comprising at least a soft magnetic layer, a seed layer, an intermediate layer and a perpendicular magnetic recording layer, which are formed in this order on a non-magnetic substrate, characterized in that said seed layer is formed as a (002) crystal plane-orientated hexagonal close-packed (hcp) structure, and said intermediate layer is formed as a double-layer by the two steps of forming a first intermediate layer which is a (110) crystal plane-orientated body-centered cubic (bcc) structure and forming a second intermediate layer which is a (002) crystal plane-orientated hexagonal close-packed (hcp) structure, in this order.
(11) A magnetic recording reproducing apparatus provided with a magnetic recording medium and a magnetic head for recording and reproducing an information in the magnetic recording medium, characterized in that the magnetic recording medium is a perpendicular magnetic recording medium as described above in any one of (1) to (9).

### EFFECT OF THE INVENTION

According to the present invention, there is provided a perpendicular magnetic recording medium, which has a perpendicular magnetic recording layer wherein the crystal c-axis in a hcp structure is oriented perpendicularly to the surface of substrate with a minimized angle variation, and the ferromagnetic crystal grains constituting the perpendicular magnetic recording layer have an extremely small average grain diameter, and which exhibits highly enhanced recording density characteristics.

### BRIEF DESCRIPTION OF THE DRAWINGS

FIG. 1 is a cross-section illustrating one example of a perpendicular magnetic recording medium according to the present invention.

FIG. 2 is a schematic illustration of (111) crystal face-orientation of a fcc structure.

FIG. 3 is a schematic illustration of (002) crystal face-orientation of a hcp structure.

FIG. 4 is a schematic illustration of (110) crystal face-orientation of a bcc structure.

FIG. 5 is a schematic illustration of an example of the magnetic recording/reproducing apparatus according to the present invention.

### REFERENCE NUMERALS

1 Non-magnetic substrate

2 Soft magnetic layer

3 Seed layer

4 First intermediate layer

5 Second intermediate layer

6 Perpendicular magnetic recording layer

7 Protective layer

10 Perpendicular magnetic recording medium

11 Medium-driving part

12 Magnetic head

13 Head driving part

14 Recording-reproducing signal system

### BEST MODE FOR CARRYING OUT THE INVENTION

The invention will now be described specifically with reference to the accompanying drawings.

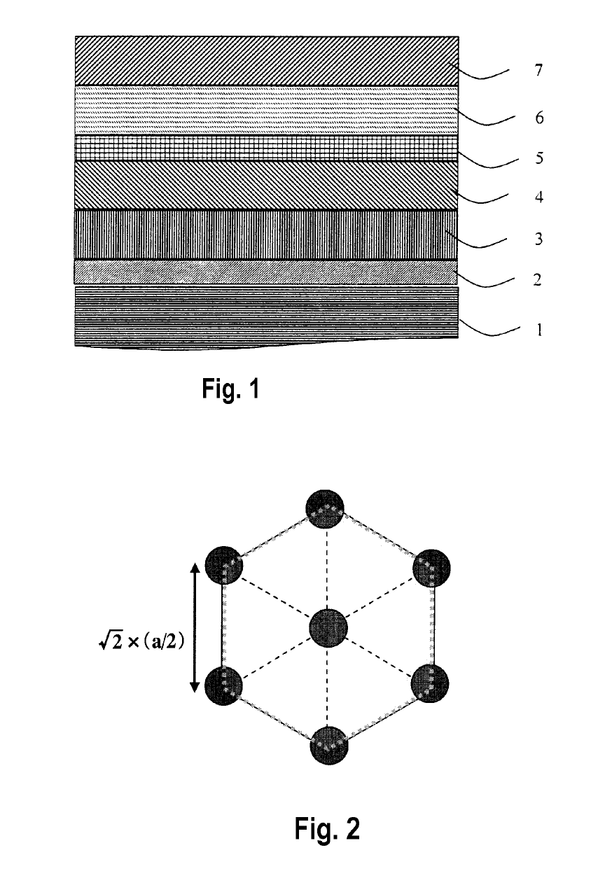

As illustrated in FIG. 1, the perpendicular magnetic recording medium 10 according to the present invention has a multilayer structure comprising at least a soft magnetic layer 2; an orientation-controlling layer having a function of controlling orientation in a layer formed thereon, which orientation-controlling is comprised of a seed layer 3, a first intermediate layer 4 and a second intermediate layer 5; and a perpendicular magnetic recording layer 6 wherein the axis of easy magnetization (i.e., crystal c-axis) is orientated in a direction approximately perpendicular to the surface of substrate 1; and an optional protective layer 7; which are formed in this order on the substrate 1.

The non-magnetic substrate 1 used in the magnetic recording medium according to the present invention is not particularly limited provided that it is comprised of a non-magnetic material, and, as specific examples thereof, there can be mentioned aluminum alloy substrates predominantly comprised of aluminum such as, for example, an Al—Mg alloy substrate; and substrates made of ordinary soda glass, aluminosilicate glass, amorphous glass, silicon, titanium, ceramics, sapphire, quartz and resins. Of these, aluminum alloy substrates and glass substrates such as crystallized glass substrates and amorphous glass substrate are widely used. As the glass substrates, mirror polished glass substrates and low surface roughness (Ra) glass substrates, for example, those having Ra <1 angstrom, are preferably used. The substrates may be textured to some extent.

In a process for producing the magnetic recording medium, the substrate is usually washed and then dried. That is, the substrates are washed and then dried for assuring sufficient interlayer adhesion. The washing can be conducted with water. Etching (i.e., reverse sputtering) may also be adopted for washing. The size of the substrates is not particularly limited.

The respective layers of the magnetic recording medium will be explained.

The soft magnetic layer is generally provided in many perpendicular magnetic recording media. The soft magnetic layer has a function of, when a signal is recorded in the magnetic recording medium, conducting recording magnetic field from a head and imposing a perpendicular magnetic recording field to a magnetic recording layer in the magnetic recording medium with enhanced efficiency.

The material for the soft magnetic layer is not particularly limited provided it has a soft magnetic property, and, as specific examples thereof, there can be mentioned FeCo alloys, CoZrNb alloys and CoTaZr alloys.

The soft magnetic layer preferably has an amorphous structure because the surface roughness (Ra) is reduced and thus lift-up of a head is minimized, thereby more improving the recording density characteristics.

The soft magnetic layer may be either a single layer or a multi-layer comprised of two or more layers. One example thereof has a multi-layer structure wherein an extremely thin film of non-magnetic material such as Ru is sandwiched between two soft magnetic layers, i.e., an anti-ferromagnetically coupled (AFC) layer with a Ru spacer layer.

The total thickness of the soft magnetic layer or layers is appropriately determined depending upon the balance between the recording/reproducing characteristics of the magnetic recording layer and the OW characteristics thereof, but the total thickness of the soft magnetic layer or layers is usually in the range of about 20 nm to 120 nm.

An orientation control layer having a function of controlling the orientation of the layer, formed thereon, i.e., the magnetic recording layer, is formed on the soft magnetic layer in the perpendicular magnetic recording medium of the invention. The orientation control layer has a multi-layer structure which comprises a seed layer, a first intermediate layer and a second intermediate layer, formed in this order on the soft magnetic layer.

The seed layer is predominantly comprised of Mg, Ti, Zr, Hf, Y, Ru, Re, Os or Zn, and is preferably a (002) crystal face-orientated layer having a hexagonal close-packed (hcp) structure.

Crystal grains in the seed layer preferably have an average grain diameter in the range of 6 nm to 20 nm. The seed layer preferably has a thickness in the range of 1 to 10 nm.

The first intermediate layer and the second intermediate layer are formed in this order on the seed layer in the magnetic recording medium according to the present invention. The first intermediate layer has a body-centered cubic (bcc) structure, and the second intermediate layer has a hexagonal close-packed (hcp) structure.

The term “bcc structure” and “hcp structure” with regard to the seed layer, the first intermediate layer and the second intermediate layer, as herein used, refer to the crystalline structures under environmental conditions wherein the magnetic recording medium of the present invention is used, i.e., at normal temperatures.

More specifically, the first intermediate layer is a (110) crystal plane-orientated bcc structure which intervenes between the seed layer which is a (002) crystal plane-orientated hcp structure and the second intermediate layer which is also a (002) crystal plane-orientated a hcp structure

The crystalline orientation of the magnetic recording layer formed on the intermediate layers varies greatly depending upon the crystalline orientation of the intermediate layers, and therefore, the crytstalline orientation controllability of the intermediate layers is important for the production of the perpendicular magnetic recording medium. If the average grain diameter of crystal grains in the intermediate layers is adequately and finely controlled, a magnetic layer comprising magnetic crystal grains having an appropriate fine grain diameter can be continuously formed. It is said that the finer the magnetic crystal grains in the magnetic recording layer, the larger the signal-to-noise ratio (SNR).

Crystal faces of a crystalline structure will be explained.

The (111) crystal face of a face-centered cubic (fcc) structure, which often occurs in the seed layer in the conventional magnetic recording medium, forms a hexagon having sides each having a length of √2×a/2 (a: lattice constant), as schematically illustrated in FIG. 2, which face is connected to each other. The (111) crystal face is the closest packed face among the crystal faces in a fcc crystal, and therefore, the (111) crystal face of a fcc structure is preferentially orientated on an amorphous soft magnetic layer.

The (002) crystal face of a hexagonal close-packed (hcp) structure is illustrated in FIG. 2. The (002) crystal face of a hexagonal close-packed (hcp) structure forms a hexagon, which is similar to the (111) crystal face of a fcc structure, and is connected to each other. However, each side of the hexagon of (002) crystal face of a hcp structure has a length of “a”. The (002) crystal face of a hcp structure is also the closest packed face among the crystal faces in a fcc crystal, and therefore, the (111) crystal face of a fcc structure is also preferentially orientated. Both of the (111) crystal face of a fcc structure, and the (002) crystal face of a hcp structure form hexagon, and therefore, even when the (002) crystal face of a hcp structure formed on (111) crystal face of a fcc structure is not sufficiently thick, a high degree of crystalline orientation can be obtained. In many conventional magnetic recording mediums, attempts have been made to improve the crystalline orientation by using two materials one of which has a fcc (111) crystal face having a side length of √2×a/2 and the other of which has a hcp (002) crystal face having a side length of “a”, wherein the two materials are chosen so that the difference between the side lengths √2×a/2 and “a” is small.

However, it is necessary for improving the recording density of a magnetic recording medium to render the crystal grains in the magnetic recording layer small as well as enhancement of the crystalline orientation. In the case when the fcc hexagonal (111) crystal face and the hcp hexagonal (002) crystal face are superposed upon another, the crystal grains are grown smoothly and the crystalline orientation is enhanced, but it is rather difficult to control the size of crystal grain in the magnetic recording layer.

A seed layer comprised of hcp crystal grains such as Mg or Ti exhibits poor affinity to Ru which is popularly adopted in an intermediate layer, and therefore, the size of ruthenium crystal grains in the intermediate layer can be easily reduced to the desired extent, but, the difference between the lattice constant of ruthenium and that of the materials for the seed layer is large, and thus the crystalline orientation in the magnetic layer tends to become poor. Crystalline structure and lattice constants of elements are shown in Table 1.

TABLE 1

| | Crystalline | Lattice Constant a | |
|---|---|---|---|
| Element | Structure | (Å) | \sqrt{3} × (a/2) (Å) |
| Mg | hcp | 3.21 | — |
| Ti | hcp | 2.95 | — |
| Zn | hcp | 2.66 | — |
| Y | fcc | 3.65 | — |
| Zr | hcp | 3.23 | — |
| Ru | hcp | 2.71 | — |
| Hf | hcp | 3.20 | — |
| Re | hcp | 2.76 | — |
| Os | hcp | 2.73 | — |
| V | bcc | 3.03 | 2.62 |
| Cr | bcc | 2.91 | 2.52 |
| Nb | bcc | 3.30 | 2.86 |
| Mo | bcc | 3.15 | 2.73 |
| Ta | bcc | 3.30 | 2.86 |
| W | bcc | 3.17 | 2.75 |

The (110) crystal face-orientation of a bcc structure in the first intermediate layer of the magnetic recording medium according to the present invention is schematically illustrated in FIG. 4.

In a hexagon of the bcc (110) crystal face, three sides thereof have a length of “a” and the other three sides have a length of √2×a/2, namely, the (110) crystal face is not equilateral. This is in a striking contrast to the above-mentioned fcc (111) crystal face and hcp (002) crystal face. In the bcc crystal, the (110) crystal face is the closest packed face, and thus, the bcc (110) crystal face is preferentially orientated on the hcp (002) crystal face in the seed layer. In contrast, the asymmetry of the non-equilateral hexagonal bcc (110) crystal face sometimes suppresses the crystal growth. However, this asymmetry makes a contribution toward the control of crystal grain size.

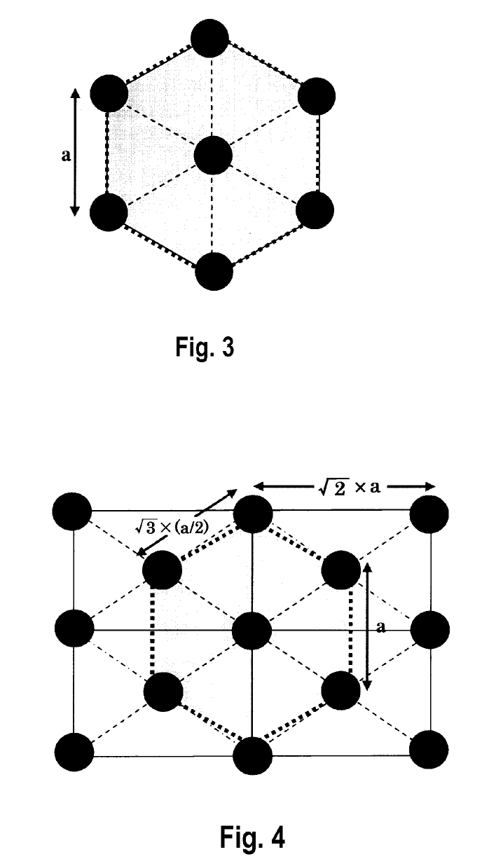

The crystalline orientation can be improved by appropriately balancing the lattice constant of the hcp crystals in the seed layer, the lattice constant in the bcc crystals in the first intermediate layer and the lattice constant in the hcp crystals in the second intermediate layer. More specifically, good crystalline orientation in a hcp/bcc laminate can be obtained by selecting the materials for the hcp (002) crystals and the bcc (110) crystals so that the hexagons in FIG. 3 and FIG. 4 have approximately the same area. The crystalline orientation in the hcp/bcc laminate is better than that in the hcp-hcp laminate. By attaining the good crystalline orientation and the appropriate control of crystal grains in an orientation control layer comprising the seed layer, the first intermediate layer and the second intermediate layer, magnetic crystal grains in the magnetic recording layer formed on the second intermediate layer can be controlled and the crystal c axis [002] axis thereof can be orientated perpendicularly to the substrate surface with minimized dispersion of angle and with a high efficiency.

It can be evaluated by the half value width Δ (delta) θ50 of a rocking curve whether the crystalline c-axis ([002] axis) in the magnetic recording layer is orientated in perpendicular to the substrate surface of the magnetic recording medium with minimized disturbance of angle, or not. The half value width Δθ50 of a rocking curve is determined as follows. A magnetic recording layer formed on a substrate is analyzed by X-ray diffractometry, i.e., the crystal face which is parallel to the substrate surface is analyzed by scanning the incident angle of X-ray to observe diffraction peaks corresponding to the crystal face. In the perpendicular magnetic recording medium comprising a cobalt-based alloy magnetic material, crystal orientation occurs so that the direction of the c-axis [002] of the hcp structure is perpendicular to the substrate surface, therefore, peaks attributed to the (002) crystal face are observed. Then the optical system is swung relative to the substrate surface while a Bragg angle diffracting the (002) crystal face is maintained. The diffraction intensity of the (002) crystal face relative to the angle at which the optical system is inclined is plotted to draw a rocking curve with a center at a swung angle of zero degree. If the (002) crystal faces are in parallel with the substrate surface, a rocking curve with a sharp shape is obtained. In contrast, if the (002) crystal faces are broadly distributed, a rocking curve with a broadly widened shape is obtained. Thus, the crystal orientation in the perpendicular magnetic recording medium can be evaluated on the basis of the half value width Δ (delta) θ50 of the rocking curve.

In the perpendicular magnetic recording medium of the present invention, a seed layer comprised of an element or alloy having a (002) crystal plane-orientated hcp structure, a first intermediate layer comprised of an element or alloy having a (110) crystal plane-orientated bcc structure and a second intermediate layer comprised of an element or alloy having a (002) crystal plane-orientated hcp structure are formed in this order. Therefore, the magnetic recording medium exhibits a small delta θ50 value as compared with the delta θ50 value of a magnetic recording medium having an orientation control layer comprising only a single intermediate layer comprised of an element or alloy having a (002) crystal plane-orientated hcp structure.

The first intermediate layer having the (110) crystal plane-orientated bcc structure is preferably predominantly comprised of chromium. More preferably the first intermediate layer comprises at least 60 atomic % of chromium. The (110) crystal plane-orientated layer with a bcc structure constituting the first intermediate layer may further comprise at least one element selected from the group consisting of Pt, Ir, Pd, Au, Ni, Al, Ag, Cu, Rh, Pb, Co, Fe, Mn, V, Nb, Ta, Mo, W, B, C, Si, Ga, In, Ti, Zr, Hf, Ru and Re.

The (110) crystal plane-orientated bcc structure constituting the first intermediate layer is comprised of crystal grains preferably having an average grain diameter in the range of 3 nm to 10 nm. The (110) crystal plane-orientated bcc structure constituting the first intermediate layer preferably has a thickness in the range of 1 nm to 50 nm.

The (002) crystal plane-orientated hcp structure constituting the second intermediate layer preferably comprises ruthenium or a ruthenium alloy. The ruthenium alloy comprises ruthenium and other elements such as Cr, Co and Ti.

The (002) crystal plane-orientated hcp structure constituting the second intermediate layer is comprised of crystal grains preferably having an average grain diameter in the range of 3 nm to 10 nm. The (002) crystal plane-orientated hcp structure constituting the second intermediate layer preferably has a thickness in the range of 5 nm to 15 nm.

The perpendicular magnetic recording layer is provided for recording a signal thereon.

The perpendicular magnetic recording layer in the magnetic recording medium of the invention is comprised of a magnetic material such as cobalt alloys. The cobalt alloys may or may not comprise an oxide, and, as specific examples of the cobalt alloys, there can be mentioned CoCr, CoCrPt, CoCrPt—O, CoCrPt—SiO₂, CoCrPt—Cr₂O_{3, CoCrPt—TiO}₂, CoCrPt—ZrO₂, CoCrPt—Nb₂O₅, CoCrPt—Ta₂O₅, CoCrPt—Al₂O_{3, CoCrPt—B}₂O_{3, CoCrPt—WO}₂, CoCrPt—WO₃, CoCrPtB, CoCrPtB—X and CoCrPtB—X—Y, where X and Y are oxides such as those which are recited for the CoCrPt alloy.

The perpendicular magnetic recording layer preferably comprise at least one magnetic layer having a granular structure comprising ferromagnetic crystal grains predominantly comprised of cobalt and further comprising grain boundaries comprised of an oxide. In this granular structure, the magnetic mutual action among the cobalt grains is weakened by the oxide grain boundaries, which leads to reduction of noise. The recording and reproducing characteristics of the perpendicular magnetic recording medium depend upon the crystalline structure and the magnetic properties of the magnetic recording layer.

The perpendicular magnetic recoding layer in the magnetic recording medium has a granular structure as mentioned above. Therefore, the intermediate layer preferably has a rough surface, which is obtained by conducting the formation of the intermediate layer by sputtering at a high gas pressure. Oxide grains in the magnetic layer are collected in the recesses on the rough surface of the intermediate layer, and consequently, the above-mentioned granular structure comprising ferromagnetic crystal grains and grain boundaries comprised of the oxide is obtained. However, adoption of too high gas pressure leads to deterioration of crystal orientation of the intermediate layer and sometimes results in an intermediate layer having a too high surface roughness. Therefore, to satisfy both of the crystal orientation and the surface roughness, it is preferable that the first intermediate layer is formed at a low gas pressure and the second intermediate layer is formed at a high pressure.

The respective layers in the perpendicular magnetic recording medium according to the present invention are usually formed by a DC magnetron sputtering method or an RF sputtering method. Imposition of RF bias, DC bias, pulse DC or pulse DC bias can be adopted for sputtering. An inert gas such as, for example, argon can be used as sputtering gas, to which O₂ gas, H₂O or N₂ gas may be added. The pressure of sputtering gas is appropriately chosen for the respective layers so as to give layers with the desired characteristics, but, the pressure is usually controlled in the range of approximately 0.1 to 30 Pa. An appropriate pressure can be determined depending upon the particular magnetic characteristics of magnetic recording medium.

A protective layer is provided so as to protect the magnetic recording medium from being damaged by the contact thereof with a head. The protective layer includes, for example, a carbon layer and a SiO₂ layer. A carbon layer is widely used. The protective layer can be formed by, for example, a sputtering method or a plasma CVD method. A plasma CVD method including a magnetron plasma CVD method is popularly used in recent years.

The thickness of protective layer is usually in the range of approximately 1 nm to 10 nm, preferably 2 nm to 6 nm and more preferably 2 nm to 4 nm.

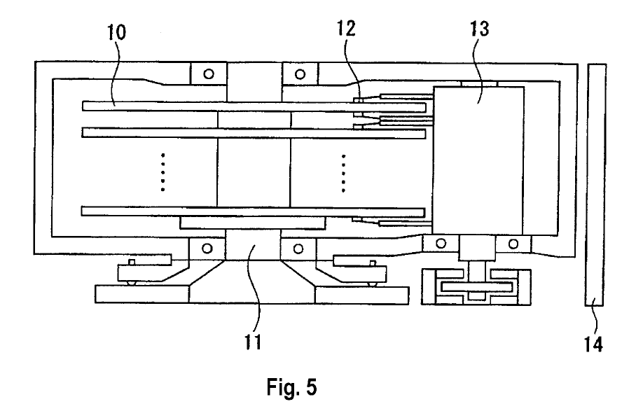

The constitution of an example of the magnetic recording-reproducing apparatus according to the present invention is illustrated in FIG. 5. The magnetic recording-reproducing apparatus comprises, in combination, the magnetic recording medium 10 as illustrated in FIG. 1; a driving part 11 for driving the magnetic recording medium 10 in the circumferential recording direction; a magnetic head 12 for recording an information in the magnetic recording medium 10 and reproducing the information from the medium 10; a head-driving part 13 for moving the magnetic head 12 in a relative motion to the magnetic recording medium 10; and a recording-and-reproducing signal treating means 14.

The recording-and-reproducing signal treating means 14 has a function of transmitting signal from the outside to the magnetic head 12, and transmitting the reproduced output signal from the magnetic head 12 to the outside.

As the magnetic head 12 provided in the magnetic recording reproducing apparatus according to the present invention, there can be used a magnetic head provided with a reproduction element suitable for high-magnetic recording density, which includes a magneto-resistance (MR) element exhibiting an anisotropic magnetic resistance (AMR) effect, a GMR element exhibiting a giant magneto-resistance (GMR) effect and a TuMR element exhibiting a tunneling magneto-resistance effect.

### EXAMPLES

The invention will now be described specifically by the following examples.

### Example 1, Comparative Example 1

A glass substrate for HD was placed in a vacuum chamber and the chamber was evacuated to a reduced pressure of below 1.0×10⁻⁵ Pa. A soft magnetic layer comprised of CoTaZr and having a thickness of 50 nm was formed on the glass substrate by sputtering at a reduced pressure of 0.6 Pa in an argon atmosphere.

Then a seed layer comprised of Mg, Ti, Hf or Re (in Examples 1-1, 1-2, 1-3 and 1-4, respectively) with a hcp structure and having a thickness of 7 nm was formed on the soft magnetic layer by sputtering at a reduced pressure of 0.6 Pa in an argon atmosphere.

On the seed layer, a first intermediate layer comprised of Cr with a bcc structure and having a thickness of 10 nm was formed by sputtering at a reduced pressure of 0.6 Pa in an argon atmosphere. Then a second intermediate layer comprised of Ru with a hcp structure and having a thickness of 10 nm was formed by sputtering at a reduced pressure of 12 Pa in an argon atmosphere.

On the second intermediate layer, a magnetic recording layer comprised of 90 (CoCr20Pt)−10(TiO₂) and then a carbon protective layer were formed to give a perpendicular magnetic recording medium.

For comparison, a comparative perpendicular magnetic recording medium was made by the same procedures as mentioned above except that a seed layer, a first intermediate layer and a second intermediate layer were formed under the following conditions. All other conditions remained the same.

Seed layer,
Thickness: 7 nm
Composition: Ni with fcc structure (Com. Ex. 1-1)
Cu with fcc structure (Com. Ex. 1-2)
Pt with fcc structure (Com. Ex. 1-3)
Mg with hcp structure (Com. Ex. 1-4)
Ti with hcp structure (Com. Ex. 1-5)
Hf with hcp structure (Com. Ex. 1-6)
Re with hcp structure (Com. Ex. 1-7)

Sputtering at 0.6 Pa in Ar atmosphere

First intermediate layer,
Thickness: 10 nm
Composition: Ru
Sputtering at 0.6 Pa in Ar atmosphere

Second intermediate layer,
Thickness: 10 nm
Composition: Ru
Sputtering at 12 Pa in Ar atmosphere

Each of the perpendicular magnetic recording mediums made in Examples 1-1 through 1-4 and Comparative Examples 1-1 through 1-7 was coated with a lubricant, and recording/reproducing characteristics thereof (i.e., signal-to-noise ratio SNR) were evaluated using Read-Write Analyzer 1632 and Spin Stand S1701MP, which are available from GUZIK, US. Further, magnetostatic property (i.e., coercive force Hc) of the perpendicular magnetic recording mediums was evaluated using a Kerr tester.

Crystal orientation of the ferromagnetic cobalt-based alloy crystal grains in each magnetic recording layer was evaluated by the half value width Δ(delta)θ50 of a rocking curve using X-ray diffractometry. Average diameter of magnetic cobalt-based alloy crystal grains was measured on a plain TEM image of the magnetic recording layer.

The above-mentioned parameters are widely used for evaluating the characteristics of perpendicular magnetic recording mediums. The evaluation results are shown in Table 2.

TABLE 2

| | | First | Second | | | | Av. Grain Diameter |
|---|---|---|---|---|---|---|---|
| | Seed Layer | Intermediate | Intermediate | SNR | Hc | [symbol] θ50 | of Co Crystals |
| Sample | (structure) | Layer (structure) | Layer (structure) | (dB) | (Oe) | (deg.) | (nm) |
| Example 1-1 | Mg (hcp) | Cr (bcc) | Ru (hcp) | 16.30 | 3521 | 3.2 | 6.8 |
| Example 1-2 | Ti (hcp) | | | 16.27 | 3863 | 3.0 | 7.4 |
| Example 1-3 | Hf (hcp) | | | 16.03 | 4108 | 3.0 | 7.8 |
| Example 1-4 | Re (hcp) | | | 16.25 | 4429 | 2.6 | 7.7 |
| Co. Ex. 1-1 | Ni( fcc) | Ru (hcp) | Ru (hcp) | 15.82 | 4672 | 3.0 | 10.3 |
| Co. Ex. 1-2 | Cu (fcc) | | | 15.01 | 4102 | 3.5 | 11.2 |
| Co. Ex. 1-3 | Pt (fcc) | | | 15.34 | 4359 | 3.2 | 10.9 |
| Co. Ex. 1-4 | Mg (hcp) | Ru (hcp) | Ru (hcp) | 15.65 | 3528 | 3.7 | 7.0 |
| Co. Ex. 1-5 | Ti (hcp) | | | 15.59 | 3994 | 3.6 | 7.7 |
| Co. Ex. 1-6 | Hf (hcp) | | | 14.37 | 3827 | 4.6 | 8.3 |
| Co. Ex. 1-7 | Re (hcp) | | | 15.69 | 4672 | 2.6 | 9.5 |

As seen from Table 2, the inventive magnetic recording mediums having the hcp/bcc/hcp orientation-controlling layer in Examples 1-1 thru 1-4 exhibit crystalline orientation approximately the same as or larger than those of the comparative recording mediums having the fcc/hcp/hcp orientation-controlling layer in Comparative Examples 1-1 thru 1-3. Further, the inventive magnetic recording mediums have magnetic cobalt alloy crystal grains of smaller size and thus exhibit larger signal-to-noise ratio (SNR) than those of the comparative magnetic recording mediums.

The inventive magnetic recording mediums having the hcp/bcc/hcp orientation-controlling layer in Examples 1-1 thru 1-4 have magnetic cobalt alloy crystal grains of approximately the same size as those of the comparative recording mediums having the hcc/hcp/hcp orientation-controlling layer in Comparative Examples 1-4 thru 1-7. Further, the inventive magnetic recording mediums exhibit crystalline orientation approximately the same as and thus larger SNR than those of the comparative magnetic recording mediums.

### Example 2, Comparative Example 2

Perpendicular magnetic recording mediums were produced by substantially the same procedures as mentioned in Example 1 and Comparative Example 1, wherein the same soft magnetic CoTaZr layer with 50 nm thickness was formed on the glass substrate by sputtering under the same conditions; a seed layer comprised of Mg with a hcp structure and having a thickness of 7 nm was formed by sputtering under the same conditions; a first intermediate layer comprised of Cr or a Cr alloy (which has the composition, shown below) with a bcc structure and having a thickness of 10 nm was formed by sputtering under the same conditions; the same second intermediate layer comprised of Ru with a bcc structure and having a thickness of 10 nm was formed by sputtering under the same conditions; the same magnetic recording layer comprised of 90 (CoCr20Pt)−10 (TiO₂) and then the same carbon protective layer were formed by sputtering under the same conditions.

The compositions of Co or Co alloys used for the first intermediate layers in Examples 2-1 thru 2-9 and Comparative Examples 2-1 thru 2-8 are as follows.
Example 2-1 Cr
Example 2-2 Cr10V
Example 2-3 Cr10W
Example 2-4 Cr10Mn
Example 2-5 Cr30Ru
Example 2-6 Cr30V
Example 2-7 Cr30W
Example 2-8 Cr30Mn
Example 2-9 Cr30Ru
Com. Ex. 1-1 Cr50V
Com. Ex. 1-2 Cr50W
Com. Ex. 1-3 Cr50Mn
Com. Ex. 1-4 Cr50Ru
Com. Ex. 1-5 Cr70V
Com. Ex. 1-6 Cr70W
Com. Ex. 1-7 Cr70Mn
Com. Ex. 1-8 Cr70Ru

Note, the chromium alloy “Cr10V” in Example 2-2 refers to that the content of vanadium in the chromium alloy is 10 atomic % and the content of chromium is the balance, i.e., 90 atomic %. This expedient expression applies to the compositions of the other chromium alloys in the other examples and the comparative examples.

Signal-to-noise ratio (SNR), coercive force (Hc) and half value width Δ(delta)θ50 of a rocking curve, of the perpendicular magnetic recording mediums were evaluated. The results are shown in Table 3.

TABLE 3

| | | | Second | | | |
|---|---|---|---|---|---|---|
| | Seed Layer | First Intermediate | Intermediate | SNR | Hc | [symbol] θ50 |
| Sample | (structure) | Layer (at %) | Layer (structure) | (dB) | (Oe) | (deg.) |
| Example 2-1 | Mg (hcp) | Cr | Ru (hcp) | 16.54 | 3632 | 3.1 |
| Example 2-2 | | Cr10V | | 16.43 | 3782 | 3.0 |
| Example 2-3 | | Cr10W | | 16.62 | 3570 | 3.0 |
| Example 2-4 | | Cr10Mn | | 16.77 | 3487 | 2.8 |
| Example 2-5 | | Cr10Ru | | 16.52 | 3527 | 3.2 |
| Example 2-6 | | Cr30V | | 16.41 | 3799 | 3.1 |
| Example 2-7 | | Cr30W | | 16.55 | 3556 | 3.2 |
| Example 2-8 | | Cr30Mn | | 16.57 | 3461 | 2.9 |
| Example 2-9 | | Cr30Ru | | 16.23 | 3508 | 3.4 |
| Co. Ex. 2-1 | Mg (hcp) | Cr50V | Ru (hcp) | 15.72 | 3627 | 3.8 |
| Co. Ex. 2-2 | | Cr50W | | 15.24 | 3552 | 3.9 |
| Co. Ex. 2-3 | | Cr50Mn | | 15.88 | 3397 | 3.6 |
| Co. Ex. 2-4 | | Cr50Ru | | 14.26 | 3109 | 4.5 |
| Co. Ex. 2-5 | | Cr70V | | 15.21 | 3529 | 4.2 |
| Co. Ex. 2-6 | | Cr70W | | 14.78 | 3328 | 4.9 |
| Co. Ex. 2-7 | | Cr70Mn | | 13.45 | 3075 | 5.5 |
| Co. Ex. 2-8 | | Cr70Ru | | 15.66 | 4021 | 3.7 |

As seen from Table 3, when the content of chromium in the Cr alloy in the first intermediate layer is smaller than 50 atomic %, the crystalline orientation is poor and the SNR becomes undesirably small.

### Example 3, Comparative Example 3

Perpendicular magnetic recording mediums were produced by substantially the same procedures as mentioned in Example 1 and Comparative Example 1, wherein the same soft magnetic CoTaZr layer with 50 nm thickness was formed on the glass substrate by sputtering under the same conditions; a seed layer comprised of Mg, Ti, Hf or Re (in Examples 3-1, 3-2, 3-3 and 3-4, respectively) with a hcp structure and having a thickness of 7 nm was formed by sputtering under the same conditions; a first intermediate layer comprised of Cr15Mo with a bcc structure and having a thickness of 10 nm was formed by sputtering at a reduced pressure of 0.6 Pa in an Ar atmosphere; the same second intermediate layer comprised of Ru with a bcc structure and having a thickness of 10 nm was formed by sputtering at a reduced pressure of 10 Pa in an Ar atmosphere; a magnetic recording layer comprised of 93 (Co13Cr13Pt)−7(WO₂) and then the same carbon protective layer were formed by sputtering under the same conditions.

For comparison, comparative perpendicular magnetic recording mediums were produced by the same procedures as mentioned above except that a seed layer was formed from an alloy comprised of 80 atomic % of Mg, Ti, Hf or Re, and 20 atomic % of Ni in Comparative Examples 3-1, 3-2, 3-3 and 3-4, respectively; or an alloy comprised of 80 atomic % of Mg, Ti, Hf or Re, and 20 atomic % of Nb in Comparative Examples 3-5, 3-6, 3-7 and 3-8, respectively. All other conditions remained the same.

Signal-to-noise ratio (SNR), coercive force (Hc) and half value width Δ (delta) θ50 of a rocking curve, of the above-mentioned perpendicular magnetic recording mediums produced in Examples 3-1 thru 3-4 and Comparative Examples 3-1 thru 3-8 were evaluated. The results are shown in Table 4.

TABLE 4

| | | First | Second | | | |
|---|---|---|---|---|---|---|
| | Seed Layer | Intermediate | Intermediate | SNR | Hc | [symbol] θ50 |
| Sample | (at %) | Layer (structure) | Layer (structure) | (dB) | (Oe) | (deg.) |
| Example 3-1 | Mg | Cr15Mo | Ru (hcp) | 16.44 | 3485 | 2.9 |
| Example 3-2 | Ti | (bcc) | | 16.49 | 4072 | 2.6 |
| Example 3-3 | Hf | | | 16.32 | 4156 | 2.8 |
| Example 3-4 | Re | | | 16.22 | 4823 | 2.4 |
| Co. Ex. 3-1 | Mg20Ni | Cr15Mo | Ru (hcp) | 13.23 | 3136 | 5.3 |
| Co. Ex. 3-2 | Ti20Ni | (bcc) | | 14.12 | 3736 | 4.6 |
| Co. Ex. 3-3 | Hf20Ni | | | 12.66 | 3285 | 6.2 |
| Co. Ex. 3-4 | Re20Ni | | | 14.76 | 4027 | 4.9 |
| Co. Ex. 3-5 | Mg20Nb | Cr15Mo | Ru (hcp) | 13.05 | 3206 | 5.6 |
| Co. Ex. 3-6 | Ti20Nb | (bcc) | | 13.26 | 3259 | 5.7 |
| Co. Ex. 3-7 | Hf20Nb | | | 12.82 | 3341 | 6.1 |
| Co. Ex. 3-8 | Re20Nb | | | 14.15 | 4182 | 5.2 |

As seen from Table 4, when the hcp crystal structure in the seed layer is collapsed to some extent by incorporating Ni or Nb in Mg, Ti, Hf or Re with a hcp structure, the crystal orientation of magnetic cobalt-alloy crystal grains worsens and the SNR is reduced by 1 dB or more. It is presumed that when the hcp crystal structure in the seed layer is collapsed, the bcc (110) crystal plane orientation of the first intermediate layer formed on the seed layer is worsened.

### INDUSTRIAL APPLICABILITY

The perpendicular recording medium according to the present invention is characterized as having an improved crystalline structure of the magnetic recording layer, more specifically, a hexagonal close-packed (hcp) structure, wherein its crystal c-axes are orientated in the perpendicular direction with minimized disturbance in angle, and ferromagnetic crystal grains in the magnetic recording layer have an extremely small average grain diameter. Therefore the perpendicular recording medium exhibits improved recording density characteristics.

Utilizing the beneficial characteristics, the perpendicular magnetic recording medium according to the present invention is suitable for a magnetic recording/reproducing apparatus, for example, a magnetic disk apparatus.

The perpendicular magnetic recording medium is expected to have a more enhanced recording density, and is also suitable for new perpendicular recording media such as, for example, ECC media, discrete track media and pattern media.

1. A perpendicular magnetic recording medium comprising at least a soft magnetic layer, a seed layer, an intermediate layer and a perpendicular magnetic recording layer, which are formed in this order on a non-magnetic substrate, characterized in that said seed layer is comprised of a (002) crystal plane-orientated hexagonal close-packed (hcp) structure, and said intermediate layer comprises a first intermediate layer comprised of a (110) crystal plane-orientated body-centered cubic (bcc) structure and a second intermediate layer comprised of a (002) crystal plane-orientated hexagonal close-packed (hcp) structure, wherein the first intermediate layer and the second intermediate layer have been formed in this order.

2. The perpendicular magnetic recording medium according to claim 1, wherein the soft magnetic layer has a non-crystalline structure.

3. The perpendicular magnetic recording medium according to claim 1, wherein the seed layer is a (002) crystal plane-orientated bcc structure mainly comprised of an element selected from the group consisting of Mg, Ti, Zr, Hf, Y, Ru, Re, Os and Zn.

4. The perpendicular magnetic recording medium according to claim 1, wherein the (110) crystal plane-orientated bcc structure constituting the first intermediate layer comprises at least 60 atomic % of chromium.

5. The perpendicular magnetic recording medium according to claim 1, wherein the (110) crystal plane-orientated layer with a bcc structure constituting the first intermediate layer comprises chromium as a main ingredient and further comprises at least one element selected from the group consisting of Pt, Ir, Pd, Au, Ni, Al, Ag, Cu, Rh, Pb, Co, Fe, Mn, V, Nb, Ta, Mo, W, B, C, Si, Ga, In, Ti, Zr, Hf, Ru and Re.

6. The perpendicular magnetic recording medium according to claim 1, wherein the (110) crystal plane-orientated bcc structure constituting the first intermediate layer is comprised of crystal grains having an average grain diameter in the range of 3 nm to 10 nm.

7. The perpendicular magnetic recording medium according to claim 1, wherein the (110) crystal plane-orientated bcc structure constituting the first intermediate layer has a thickness in the range of 1 nm to 50 nm.

8. The perpendicular magnetic recording medium according to claim 1, wherein the (002) crystal plane-orientated hcp structure constituting the second intermediate layer comprises ruthenium or a ruthenium alloy.

9. The perpendicular magnetic recording medium according to claim 1, wherein the perpendicular magnetic recording layer comprises at least one magnetic layer having a granular structure comprising ferromagnetic crystal grains and crystal boundaries comprised of a non-magnetic oxide.

10. A process for producing a perpendicular magnetic recording medium comprising at least a soft magnetic layer, a seed layer, an intermediate layer and a perpendicular magnetic recording layer, which are formed in this order on a non-magnetic substrate, characterized in that said seed layer is formed as a (002) crystal plane-orientated hexagonal close-packed (hcp) structure, and said intermediate layer is formed as a double-layer by the two steps of forming a first intermediate layer which is a (110) crystal plane-orientated body-centered cubic (bcc) structure and forming a second intermediate layer which is a (002) crystal plane-orientated hexagonal close-packed (hcp) structure, in this order.

11. A magnetic recording reproducing apparatus provided with a magnetic recording medium and a magnetic head for recording and reproducing an information in the magnetic recording medium, characterized in that the magnetic recording medium is a perpendicular magnetic recording medium as claimed in claim 1.
